(19) United States
(12) Patent Application Publication
(10) Pub. No.: US 2015/0189901 A1
(43) Pub. Date: Jul. 9, 2015

(54) Resistant Starch Food Bar System

(71) Applicant: Trent Baker, Salt Lake City, UT (US)

(72) Inventor: Trent Baker, Salt Lake City, UT (US)

(73) Assignee: EPIC TECHNOLOGY LLC, Salt Lake City, UT (US)

(21) Appl. No.: 14/151,219

(22) Filed: Jan. 9, 2014

(51) Int. Cl. A23L 1/0522

(52) U.S. Cl. CPC A23L 1/0522; A23L 1/05226

(57) ABSTRACT

One embodiment of the present invention relates to an uncooked consolidated ready to eat food bar system containing at least 15 grams of resistant starch. The food bar system includes a liquid, a fiber substance, and a gelling substance. The fiber substance may be a high resistant starch substance including at least one of potato starch, tapioca starch, and plantain flour. The gelling substance is configured to at least consolidate the liquid and fiber substance and may include gelatin, flax, or chia. The food bar system may include a flavoring substance such as a cocoa and a sweetener. The food bar system may also include a supplemental substance such as a probiotic, protein powder, vitamin mixture, and/or ketogenic oil.

### FIELD OF THE INVENTION

The invention generally relates to portable food bars. In particular, the present invention relates to portable food bars comprising fermentable insoluble fiber.

### BACKGROUND OF THE INVENTION

Food bars have become a common portable strategy for consuming food. A food bar is generally a rectangular non-liquid composition of multiple food ingredients. Conventional foods bars include energy bars, candy bars, etc. Food bars may be individually vacuum-packaged to facilitate hermetic transportation and increased shelf life.

Recent research has discovered the importance of microorganisms for health. The human body contains over ten times more microbial cells than human cells. The microorganisms that reside in the human body are commonly referred to as the microbiota or microbiome. The health of the microbiome depends on the balance of healthful/good bacteria versus negative/bad bacteria. The relative health of the microbiome has also been linked to numerous diseases including diabetes, rheumatoid arthritis, muscular dystrophy, multiple sclerosis, fibromyalgia, and obesity. For example, an unhealthy microbiome could be a significant contributor of one or more of the conditions above. Modern industrialized populations have experienced a dramatic increase in obesity and other health diseases which may be directly related to an unhealthy microbiome.

Conventional supplements for improving microbiome health, referred to as “probiotics”, are directed at introducing new beneficial microorganisms into the human body so as to become part of the recipient's microbiome. The injection of new beneficial microorganisms is intended to encourage the proliferation of beneficial bacteria over negative bacteria. Unfortunately, probiotic supplements generally lack sufficient beneficial bacteria volume to overcome existing negative bacteria. Most probiotics include approximately one billion organisms, while the human microbiome is estimated to contain over one hundred trillion organisms. Therefore, unless the human host destroys all existing bacteria via enteral or parenteral antibiotics, conventional probiotic supplements are generally ineffective at overcoming proliferation of negative bacteria.

Rather than introducing additional organisms to the human host, a new strategy for improving microbiome health includes providing “prebiotic” supplements to feed the beneficial bacteria and thereby encourage overall microbiome health. Unfortunately, conventional prebiotic theory focused on providing soluble fibers such as inulin, oligofructose, and xylooligosaccharides which have failed to provide sufficient nutrition for the beneficial bacteria at reasonable quantities. By contrast, insoluble fibers were incorrectly thought to negatively influence digestion. New research indicates that certain volumes of insoluble and fermentable fibers known as “resistant starches” may provide significant improvements to microbiome health by feeding the beneficial bacteria at reasonable quantities. A minimum daily dosage of 30 grams of resistant starch has been shown to provide significant benefits, including increased insulin sensitivity which is one of the primary causes of obesity.

Therefore, there is a need in the industry for a portable food bar delivery system for prebiotics including at least 30 grams of resistant starch.

### SUMMARY OF THE INVENTION

The present invention relates to food bars. One embodiment of the present invention relates to an uncooked, consolidated, ready-to-eat food bar system containing at least 15 grams of resistant starch. The food bar system includes a liquid, a fiber substance, and a gelling substance. The fiber substance may be a high resistant starch substance including at least one of potato starch, tapioca starch, and plantain flour. The gelling substance is configured to at least consolidate the liquid and fiber substance and may include gelatin, flax, or chia. The system may include a flavoring substance such as a cocoa and a sweetener. The food bar system may also include a supplemental substance such as a probiotic, protein powder, vitamin mixture, and/or ketogenic oil. A second embodiment of the present invention relates to a method for consolidating a food bar containing at least 15 grams of resistant starch.

Embodiments of the present invention represent a significant advance in the field of microbiome supplementation. Conventional probiotic and prebiotic supplements have been ineffective at improving the health of the human microbiome. The ingestion of resistant starch efficiently encourages local benefits to the large intestine and systemic benefits to the human host. The local benefits to the large intestine include increased mineral absorption, increased beneficial flora, decreased pathogen levels, and decreased diarrhea. The systemic benefits to the human host include improved insulin sensitivity and fatty acid oxidation. The delivery of resistant starch in a consolidated food bar provides a convenient and portable system capable of delivering microbiome benefits to users who may otherwise avoid digestive supplementation. In addition, testing has indicated that a food bar containing at least 15 grams of resistant starch induces a high satiety and low insulin/blood sugar effect beyond what would be expected for the number of calories. Therefore, in addition to providing the prebiotic microbiome benefits of the resistant starch, embodiments of the present invention could be used to provide a low calorie food bar that causes a high amount of satiety without significantly raising insulin or blood sugar.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the

Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a perspective view of a food bar in accordance with one embodiment of the present invention; and

FIG. 2 illustrates a flow chart of a method for consolidating a food bar in accordance with an alternative embodiment of the present invention.

### DETAILED DESCRIPTION OF THE INVENTION

The present invention relates to food bars. One embodiment of the present invention relates to an uncooked, consolidated, ready-to-eat food bar system containing at least 15 grams of resistant starch. The food bar system includes a liquid, a fiber substance, and a gelling substance. The fiber substance may be a high resistant starch substance including at least one of potato starch, tapioca starch, and plantain flour. The gelling substance is configured to at least consolidate the liquid and fiber substance and may include gelatin, flax, or chia. The food bar system may include a flavoring substance such as a cocoa and a sweetener. The food bar system may also include a supplemental substance such as a probiotic, protein powder, vitamin mixture, and/or ketogenic oil. A second embodiment of the present invention relates to a method of consolidating a food bar containing at least 15 grams of resistant starch. Also, while embodiments are described in reference to a food bar system, it will be appreciated that the teachings of the present invention are applicable to other areas.

The following terms are defined as follows:

Resistant Starch—a type of fiber that is both insoluble and fermentable, the sum of starch and products of starch degradation not absorbed in the small intestine of healthy individuals.

Gelling substance—a dry substance configured to consolidate a composition in combination with a liquid. For example, gelatin is a gelling substance which can consolidate a combination of dry substances when combined with a liquid.

High Resistance Starch substance—a dry substance having at least a 50% resistant starch content by weight. For example, raw potato starch powder contains 75% resistant starch.

Fiber substance—a dry substance comprising at least one fiber, including but not limited to soluble, insoluble, and fermentable fibers. One type of fermentable fiber is resistant starch.

Sweetener—a composition known to cause a sweet taste when ingested.

Uncooked—a composition which has not been heated over 110 degrees Fahrenheit.

Consolidation—a chemical reaction causing a mixture of solid and liquid ingredients to combine into a single composition. For example, one tablespoon of gelatin and three tablespoons of water may be combined to form a consolidated composition.

Consumption of resistant starch has been reported to produce numerous beneficial effects on the human microbiome. Resistant starch is a type of fiber that is both insoluble and fermentable. An insoluble fiber is one that substantially avoids digestion in the stomach and small intestine. A fermentable fiber is one that is capable of fermentation in the colon. One suggested mechanism for the many benefits correlated with resistant starch consumption relates to the increased production of short chain fatty acids such as butyrate, which have known beneficial effects. Additional systemic health benefits of resistant starch consumption include increased insulin sensitivity, decreased postprandial blood glucose and insulin response, increased satiety (via activation of hormones PYY and GLP-1), improved fecal mobility, and decreased intestinal inflammatory conditions causing diarrhea. Most of the health benefits are thought to occur as a result of at least 30 grams of resistant starch consumption per day. Embodiments of the present invention include at least 15 grams. A food bar containing 15 grams of resistant starch may be consumed twice a day to obtain the minimum effective dosage. However, certain users may be benefit from slowly increasing their resistant starch supplementation from an initial 7.5 grams to avoid undesirable gastrointestinal discomfort.

It has unexpectedly been discovered that a quantity of 15 grams of resistant starch can be consolidated into a food bar that is pleasing to sensory properties without requiring the inclusion of unhealthy ingredients. The food bar may be formulated to be completely devoid of likely allergenic substances including dairy, eggs, shellfish, soy, fish, peanuts, tree-nuts, and wheat. The food bar may also be completely devoid of known unhealthy substances including genetically modified organisms (GMO), trans-fats (hydrogenated oils), and suspected carcinogenic or hormone-disrupting chemicals such as saccharin, aspartame, carageenan, dyes, parabens, plastics, etc. The food bar may be formulated to include specific supplemental objectives corresponding to quantities of macronutrients (protein, carbohydrates, fat) and/or micronutrients (vitamins, minerals, etc.). Likewise, the food bar may include various flavor substances and/or coatings. For example, one embodiment includes cocoa, stevia, coconut, and almond in addition to the standard fiber, gelling, and liquid substances. Testing has indicated that a balance of cocoa, stevia, coconut, and almond produces a pleasing chocolate coconut almond flavor. Various specific formulations and tested ingredients will be discussed in more detail below.

Additional nutritional supplements may be incorporated into a consolidated food bar that contains at least 15 grams of resistant starch. To achieve specific nutritional objectives beyond resistant starch supplementation (prebiotic), additional liquid or dry ingredients may be incorporated into the food bar. For example, a high protein supplement such as whey protein powder may be added to increase total protein content of the food bar. Likewise, a medium chain triglyceride (MCT) oil could be added to increase the fat content and ketogenic properties of the food bar. In addition, a probiotic liquid or dry supplement could be incorporated into the food bar system. Experiments have been conducted using powder probiotics and liquid active probiotic supplements. Providing both a probiotic supplemental substance with the prebiotic resistant starch may provide a synergistic beneficial effect on the host microbiome. Various other nutritive supplements may be added in accordance with embodiments of the present invention.

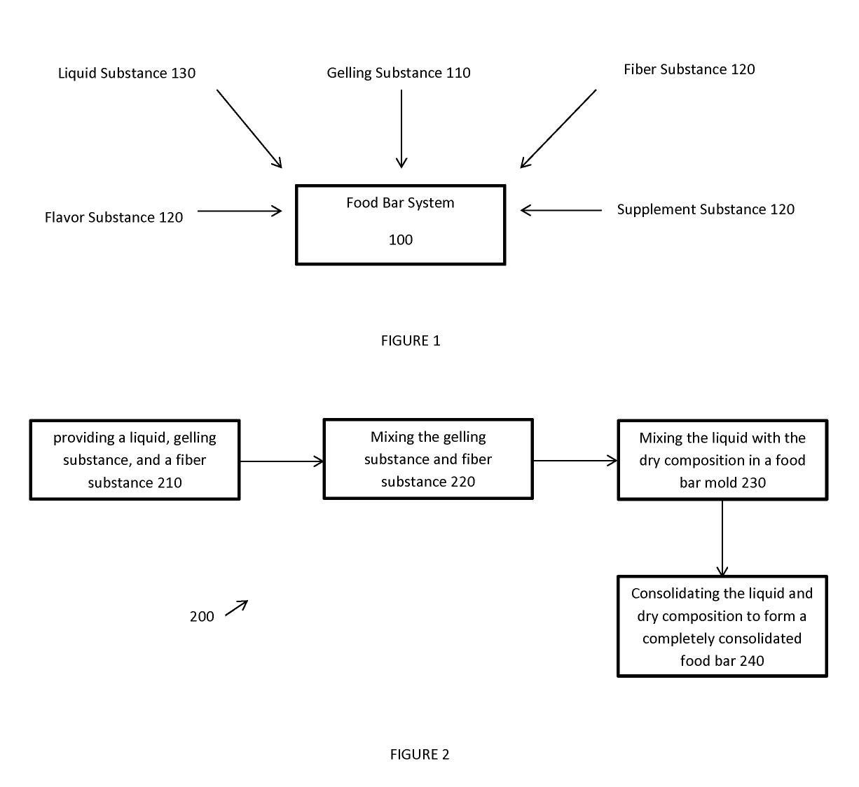

Reference is initially made to FIG. 1, which illustrates a food bar in accordance with a one embodiment of the present invention, designated generally at 100. The food bar 100 includes a gelling substance 110, a fiber substance, 120, a liquid 130, a flavor substance 140, and a supplement substance 150. Various gelling substances 110 or binders may be used including but not limited to gelatin, chia seed powder, flax seed powder, and egg powder. Gelling substances 110 consolidate dry and wet ingredients upon contact. A particular quantity of gelling substance 110 is necessary to completely consolidate the food bar based on the ratio of total dry ingredients to wet ingredients. A complete consolidation of substances refers to substantially binding all ingredients in a single composition having a minimum hardness necessary to maintain consolidation. In order to consolidate all of the dry ingredients, it has been discovered that the dry ingredients must be properly mixed or sifted with the gelling substance to ensure consolidation of all substances. The term “sifted” refers to a fine particle mixing process of the dry ingredients. The inclusion of additional dry or liquid substances such as cocoa, stevia, protein powder, MCT oil, etc. would require an additional volume of gelling substance to induce complete consolidation. The specific amount of gelling substance 110 may be determined by calculating the total amounts of dry and wet ingredients. Gelatin is a dry powder produced by animal collagen. It is preferable to use gelatin produced from animal raised in a human manner consistent with their natural diet. For example, bovine gelatin from grass-fed, pasture raised cows is preferable to conventionally raised feedlot cows fed an inflammatory diet of GMO corn and soy. Flax and chia seed powders are also well known gelling substances and are preferably derived from organically farmed plants. Egg powders may also be used as a gelling substance but may require refrigeration. The gelling or binding action of a gelling substance may also be delayed by heating the liquid prior to mixture. Use of non-animal gelling substances may accomplish certain moral objectives to animal products including religious, vegan and vegetarian.

The fiber substance 120 component of the system 100 includes the at least 15 grams of resistant starch. One particular type of fiber substance 120 is a high resistant starch substance that contains at least 50% by weight of resistant starch. Various types of high resistant starch substances include raw potato starch, raw tapioca starch, and raw plantain flour. Raw potato starch is produced from raw potatoes. One example brand of raw potato starch is Bob's Red Mill. Raw tapioca starch and plantain flour are also produced from raw tapioca and raw plantains respectively. Resistant starch is a crystalline structure of starch molecules which are sensitive to temperature. Heating or cooking a fiber substance containing resistant starch will result in a significant decrease in the total resistant starch. Therefore, a food bar that is heated or cooked with similar ingredients will not have the same resistant starch composition as one that is maintained in a raw state. Conventional food manufacturing includes high temperature pasteurizing and cooking to kill potential bacteria and increase shelf life. However, the food bar embodiments of the present invention must be maintained in a counter-intuitive raw state to preserve the resistant starch content. Various other types of non-high resistant starch fiber substances 120 may be included in sufficient quantities to include the 15 grams of resistant starch. The specific type of fiber substance may be selected to avoid allergies, increase certain nutritive objectives, and/or alter flavor.

A liquid 130 must be combined with the gelling and fiber substances 110, 120 to cause the consolidation of the food bar. As discussed above, the specific ratio of the liquid must be determined by the amount of total dry ingredients, including the gelling substance 110, fiber substance 120, and any dry flavor substances 140. The liquid 130 to dry substance ratio by weight is at least two. The liquid may be any mixture of liquids, but different viscosities have been determined to affect the required gelling substance volume necessary to produce a completely consolidated food bar system 100. For example, a thick milk or kefir yogurt will require less gelling substance than an equal volume amount of water. Various liquids may also be used in whole or in combination with water as flavor or supplement substances for purposes of nutritional or sensory enhancement. For example, MCT oil may be used to improve the nutritive objective of a ketogenic state. A liquid kefir may be used as a supplement and flavor substance. A milk (cow, goat, almond, hemp, soy, etc.) may be also added as a supplement and as a flavor substance. Certain liquids will change the shelf life of the resulting food bar system 100 and may require refrigeration.

Various flavor substances 140 may be added to improve sensory perception of the food bar system 100. For example, cocoa powder has been determined to improve the appearance of the food bar system 100 by creating a chocolate brownie appearance. Cocoa powder is preferably roasted to increase the flavonoid content. Alternative cocoa powders may be also be used. A sweetener such as stevia has been determined to balance the bitter and chalky flavors of the cocoa and fiber substance. Experiments have resulted in the specific example rations of the example formulations below. It will be appreciated that alternative flavor substances such as coconut flakes, lemon rind and nut bits may also be incorporate to improve visual, texture, and taste of the resulting food bar 100.

Reference is next made to FIG. 2, which illustrates a flow chart in accordance with a second embodiment of the present invention, designated generally at 200. The illustrated method for consolidating a ready to eat food bar containing at least 15 g of resistant starch comprises multiple acts. The method includes providing a liquid, gelling substance, and fiber substance, wherein the liquid includes a quantity of at least twice the gelling substance and fiber substance by weight, act 210. The gelling substance and fiber substance are mixed to form a dry composition, act 220. The liquid is mixed with the dry composition in a food bar mold, act 230. An alternative method may include mixing (also known as “blooming”) the gelling substance with the liquid prior to mixing with the remaining substances. The liquid and dry composition is consolidated to form a completely consolidated food bar, act 240. The act of consolidating the food bar 240 may include consolidating within a mold. The mold may be composed of silicone to avoid adhesion and enable convention removal. In addition, the method may be performed in bulk including cutting or dividing the final completely consolidated product to form the individual ready to eat food bars. The method may also include individually packaging the completely consolidated food bars in sealed packages conforming to retail sale.

### SPECIFIC EXAMPLES

1. Chocolate Coconut Almond flavor—16 grams resistant starch
2 Tablespoon raw potato starch
2 Tablespoons gelatin powder
¼ tsp stevia extract (100%)
1 cup water
½ Tablespoon cocoa powder
1 Tablespoon coconut flakes
1 Tablespoon almond bits

Instructions for manufacturing:
1. Mix or sift dry ingredients (potato starch, gelatin, stevia, cocoa)
2. Mix or blend dry ingredients with water
3. Allow mixture to partially consolidate
4. Mix coconut flakes and almond bits
5. Allow mixture to completely consolidate
6. Remove from receptacle and package

Nutritional Label Information:
Calories 197
Fat 6.3 g
Carbohydrates 23.9 g
Protein 14.2 g

Experiments have indicated that the above formulation produces an optimal flavor, appearance, and texture sensory perception with optimal nutritional ingredients. Alternative embodiments may use additional stabilizers, less expensive sweeteners, etc. to achieve alternative objectives.

2. Vegan Lemon—Plantain flour, Chia/Flax seed powder, stevia, water, Lemon rind.

3. High Protein—Potato starch, gelatin, stevia, cocoa, whey protein powder.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

1. An uncooked consolidated ready to eat food bar system containing at least 15 g of resistant starch comprising a mixture of:
a liquid;
a fiber substance, wherein the fiber substance is a resistant starch substance including at least one of potato starch, tapioca starch, and plantain flour, wherein the fiber substance includes at least 15 g of resistant starch; and
a gelling substance, wherein the gelling substance includes a quantity configured to at least consolidate the liquid and fiber substance.

2. The system of claim 1, wherein the mixture includes a ratio of the liquid to other substances of at least 2 by weight.

3. The system of claim 1, wherein the fiber substance comprises at least 5% of the total system weight.

4. The system of claim 1, wherein the gelling substance includes at least one of gelatin, flax, and chia.

5. The system of claim 1, further including a flavoring substance.

6. The system of claim 5, wherein the flavoring substance includes cocoa and a sweetener.

7. An uncooked consolidated ready to eat food bar system containing at least 15 g of resistant starch comprising a mixture of:
a liquid;
a fiber substance comprising at least 15 grams of resistant starch and wherein the fiber substance is at least 5% of the total system weight; and
a gelling substance, wherein the gelling substance includes a quantity configured to at least consolidate the liquid and fiber substance.

8. The system of claim 7, wherein the mixture includes a ratio of the liquid to other substances of at least 2 by weight.

9. The system of claim 7, wherein the fiber substance is a high resistant starch substance including at least one of potato starch, tapioca starch, and plantain flour

10. The system of claim 7, wherein the gelling substance includes at least one of gelatin, flax, and chia.

11. The system of claim 7, further including a flavoring substance.

12. The system of claim 10, wherein the flavoring substance includes cocoa and a sweetener.

13. A method for consolidating a ready to eat food bar containing at least 15 g of resistant starch comprising the acts of:
providing a liquid; a fiber substance, wherein the fiber substance is a high resistant starch substance including at least one of potato starch, tapioca starch, and plantain flour; a gelling substance, wherein the gelling substance includes a quantity configured to at least consolidate the liquid and fiber substance, wherein the liquid includes a quantity of at least twice the gelling substance and fiber substance by weight;
mixing the gelling substance and fiber substance to form a dry composition;
mixing the liquid with the dry composition in a food bar mold; and
consolidating the liquid and dry composition to form a consolidated food bar.

14. The method of claim 13, wherein the gelling substance includes at least one of gelatin, chia, and flax powder.

15. (canceled)

16. The method of claim 13, wherein the act of mixing the gelling substance and fiber substance to form a dry composition includes sifting.

17. The method of claim 13, wherein the act of mixing the gelling substance and fiber substance to form a dry composition includes mixing a flavor substance.

18. The method of claim 13, wherein the act of mixing the liquid with the dry composition in a food bar mold includes blending.

19. The method of claim 13, wherein the act of consolidating the liquid and dry composition to form a consolidated food bar includes cooling.

20. The method of claim 13, wherein the act of mixing the liquid with the dry composition in a food bar mold includes heating the liquid to a temperature between 80 and 100 degrees Fahrenheit.
